(19) United States
(12) Patent Application Publication
(10) Pub. No.: US 2012/0074726 A1
(43) Pub. Date: Mar. 29, 2012

(54) CONSOLE BOX

(75) Inventors: Hajime TAKAI, Kiyosu-shi (JP); Minoru SHIBATA, Kiyosu-shi (JP); Toshiyasu SAYAMA, Kiyosu-shi (JP); Naoki OMATSU, Kiyosu-shi (JP)

(73) Assignee: TOYODA GOSEI CO., LTD., Kiyosu-shi (JP)

(21) Appl. No.: 13/223,382

(22) Filed: Sep. 1, 2011

(30) Foreign Application Priority Data
Sep. 29, 2010 (JP) 2010-218485

(51) Int. Cl. B60N 3/00

(52) U.S. Cl. 296/24.34

(57) ABSTRACT

A console box includes a console lid, and paired rails for lid. The console lid is installed to the two lid rails. The paired lid rails extend in a vehicular traveling direction, and in a vehicular height-wise direction. The console lid reinforces the console box in the vehicular width-wise direction. The two lid rails reinforce the console box in the vehicular traveling direction, and in the vehicular height-wise direction.

### INCORPORATION BY REFERENCE

The present invention is based on Japanese Patent Application No. 2010-218,485, filed on Sep. 29, 2010, the entire contents of which are incorporated herein by reference.

### BACKGROUND OF THE INVENTION

1. Field of the Invention

The present invention relates to a console box to be put in place within the passenger room of vehicle.

2. Description of the Related Art

It has been known that a conventional console box for automobile commonly comprises a pair of side panels, a box-shaped accommodation unit, a console lid, and an arm rest. The accommodation unit is disposed between the paired side panels. The console lid covers the accommodation unit openably and closably. The arm rest is installed to the paired side panels, and is disposed on a much upper side than is the console lid. In order to make automobiles lightweight, the two side panels are made of resin in general.

A conventional console box is usually fixed on the floor of vehicular body with screws. When a conventional console box is provided with an arm rest, it is necessary to position the arm rest at such a height approximately at which the elbow of a passenger sitting on the driver or navigator seat is present. Therefore, a conventional console box with an arm rest becomes large-sized because it comes to have a tall height from the floor of vehicular body. Moreover, a conventional console box has a small dimension relatively in the width-wise direction of vehicle, that is, in a direction in which the paired side panels separate away from each other. In addition, it is needed to enhance a conventional console box in rigidities, especially, in rigidity in the vehicular width-wise direction and in rigidity in the vehicular height-wise direction, in the case of providing the conventional console box with an arm rest, because passengers apply loads to the arm rest.

It is believed possible to reinforce a conventional console box in the vehicular width-wise direction by bridging a reinforcement wall over a pair of the side panels. Moreover, it is believed possible to reinforce the conventional console box in the vehicular height-wise direction as well by giving the reinforcement wall a height that is virtually equal to that of the two side panels.

However, there might be cases where a conventional console box cannot be provided with such a reinforcement wall, depending on the conventional console box's configurations and intended uses or applications. For example, when trying to utilize a box-shaped dent, which the console lid, arm rest and paired side panels demarcate and in which the console lid makes the bottom wall, as a second accommodation unit, the console lid and the arm rest separate away from each other greatly in the vehicular height-wise direction. If such is the case, a reinforcement wall to be provided might possibly interfere with the opening and closing operations of the console lid. Accordingly, it is required that an opened space be provided between the paired side plates at one of the top and bottom ends of the console lid at least, namely, at one of the operational opening and closing ends of the console lid at least. Consequently, it is not possible to join between the paired side plates with a reinforcement wall.

Moreover, when another component part like an air-conditioning duct, for instance, is put in place within a conventional console box, the conventional console box might be provided with an insertion opening at one of the opposite ends in the vehicular traveling direction. That is, one of the opposite ends of the conventional console box might be utilized as an opening for inserting the other component part into the interior of the conventional console box (i.e., into the space between a pair of the side panels). In this instance, it is not possible to bridge a reinforcement wall between the paired side panels at one of the opposite ends in the vehicular traveling direction.

Making a pair of the side panels thicker is believed to enable a conventional console box to exhibit upgraded rigidities in the vehicular width-wise direction, and in the vehicular height-wise direction. If such is the case, however, the conventional console box has adversely come to have a larger dimension in the vehicular width-wise direction. Moreover, such designing as providing the paired side panels with a heavier thickness might not be allowed, because the dimensions of passenger room and the dimensions of seat restrict the dimensions of conventional console box. On the contrary, when the conventional console box does not have a larger dimension in the vehicular width-wise direction, the internal accommodation unit has adversely become small-sized.

In addition, it has been required in recent years to make a conventional console box much larger in order that it can accommodate large-sized luggage like tote bags therein. Accordingly, it has been required for a conventional console box to exhibit much higher rigidity. In this instance, the console lid has to be built larger eventually as being accompanied by the enlarging accommodation unit. A common console lid slides or rotates to open and close the accommodation unit. However, it might be difficult for users to operate a large-sized console lid to open and close the accommodation unit in such a small space like a vehicular passenger room, because a large-sized console lid requires a larger spatial allowance or room for the sliding or rotation. A bellows-shaped console lid, which is disclosed in Japanese Unexamined Patent Publication (KOKAI) Gazette No. 2000-255,323, for instance, is believed to be suitable for a console lid for large-sized console box because it merely requires a smaller spatial allowance or room for the opening and closing operations, although it has a large size.

Moreover, it is believed that using such a bellows-shaped console lid to assemble a console box makes it possible to reinforce the resulting console box in the vehicular width-wise direction. Even if such is the case, however, the resultant console box might possibly exhibit rigidity inadequately in the vehicular height-wise direction.

### SUMMARY OF THE INVENTION

The present invention has been developed in view of the aforementioned circumstances. It is therefore an object of the present invention to provide a console box that exhibits better rigidities in the vehicular width-wise and height-wise directions without ever being provided with any reinforcement wall.

A console box according to the present invention solves the above-described problems. The present console box is to be disposed in a vehicular passenger room, and comprises:

a pair of side panels being made of resin, and being separated away from each other in a vehicular width-wise direction;

a pair of rails for lid, each of the paired rails being integrated with each of the paired side panels;

an accommodation module being formed as a box shape, and being disposed in a space between the paired side panels;

a console lid being formed as a bellows shape that is bendable along the paired rails for lid, covering the accommodation module so as to make the accommodation module openable and closable, and having opposite ends in the vehicular width-wise direction, one of the opposite ends being installed slidably to one of the paired rails for lid and the other one of the opposite ends being installed slidably to the other one of the paired rails for lid;

an arm rest being installed to the paired side panels, and being disposed above the console lid so as to separate away from the console lid; and

the paired rails for lid comprising:
an upper rail member being disposed above the accommodation module, and extending in a vehicular traveling direction; and
a side rail member being disposed more rearward, or more forward, than is the accommodation module, being disposed continuously to and from the upper rail member, and extending in a vehicular height-wise direction.

The console box according to the present invention not only comprises the bellows-shaped console lid but also the paired rails for lid. The bellows-shaped console lid reinforces the present console box in the vehicular width-wise direction. The paired rails for lid reinforce the present console box in the vehicular height-wise direction as well as in the vehicular travelling direction, without ever being provided with any reinforcement wall. Therefore, the present console box exhibits better rigidities in the vehicular width-wise direction, in the vehicular height-wise direction, and in the vehicular travelling direction.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a perspective diagram for schematically illustrating a console box according to Embodiment No. 1 of the present invention.

FIG. 2 is an exploded perspective diagram for schematically illustrating the present console box according to Embodiment No. 1.

FIG. 3 is a cross-sectional diagram for schematically illustrating how the present console box according to Embodiment No. 1 appears when it is cut imaginarily in the front/rear direction.

FIG. 4 is another cross-sectional diagram for schematically illustrating how the present console box according to Embodiment No. 1, which is cut imaginarily in the front/rear direction, appears when it accommodates baggage (e.g., a tote bag) therein.

FIG. 5 is a cross-sectional diagram for schematically illustrating how a console box according to Embodiment No. 2 of the present invention, which is cut imaginarily in the front/rear direction, appears when it accommodates first baggage therein.

FIG. 6 is a cross-sectional diagram for schematically illustrating how the present console box according to Embodiment No. 2, which is cut imaginarily in the front/rear direction, appears when it not only accommodates the first baggage therein but also holds second baggage thereon.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

A console box according to the present invention comprises a pair of side panels, a pair of rails for lid, an accommodation module, a console lid, and an arm rest. At least the paired side panels are made of resin. Constituent members other than the paired side panels, such as the paired rails for lid, can be made of material other than resin, such as metal. Forming the two side panels of resin enables the present console box to have a lighter weight because the side panels occupy a greater portion of the present console box. In order to make the present console box more lightweight, it is preferable that the constituent parts of the present console box other than the paired side panels can be formed of resin as well.

The paired side panels can comprise one and only constituent member, respectively, or can comprise two or more constituent members, respectively. For example, it is preferable that one of the paired side panels can comprise an inner panel member, and an outer panel member. The inner panel member is disposed inside the console box according to the present invention, namely, near or next to the accommodation module. The outer panel member is disposed outside the inner panel member. The outer panel member is a member that makes the outermost face of the present console box. For this reason, a material whose rigidity is poor relatively might be selected to make the outer panel member while taking the decorativeness into consideration. If such is the case, it is preferable to select another material whose rigidity is better than that of the material making the outer panel member in order to make the inner panel member. Moreover, in this instance, it is preferable to integrate the inner panel member with the one of the paired rails for lid. Integrating the inner panel member with the one of the two rails for lid enables the present console box to demonstrate more upgraded rigidities in the vehicular height-wise direction and in the vehicular traveling direction, because the paired rails for lid are members that reinforce the present console box as described above. It is possible to integrate the inner panel member with the outer panel member by a common process such as adhesion bonding, weld bonding, heat crimping, and fastening with screw.

The paired rails for lid can be made of material that is the same as the material making the paired side panels. Alternatively, the two rails can be made of material that is different from the material making the two side panels. The paired rails can be molded integrally with the paired side panels. Alternatively, the two rails can be integrated with the two side panels by one of the above-described common processes after being molded independently of or separately from the two side panels.

It is allowable that the arm rest can be simply installed to the paired side panels. That is, the arm rest can be attached to the two side panels directly, or can be attached to the two side panels indirectly by way of another certain member. Moreover, the arm rest can be disposed slidably to or rotatably about the paired side panels, or can be fixed unoperably to the paired side panels. When making the arm rest slidable to the two side panels, the console box according to the present invention can be provided with paired rails for guiding the arm rest. On this occasion, the two arm-rest guiding rails can be made of material that is identical with the material making the paired side panels, or can be made of material that differs from the material making the two side panels. In addition, the paired arm-rest guiding rails can be molded integrally with the paired side panels, or can be integrated with the paired side panels by one of the above-described common processes after being molded independently of or separately from the paired side panels.

The console box according to the present invention can further comprise another member, such as an air-conditioning duct, a drawer or a beverage-container holder, for instance.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### EMBODIMENTS

Hereinafter, the present invention will be described in more detail with reference to some of specific embodiments of the console box according to the present invention.

### Embodiment No. 1

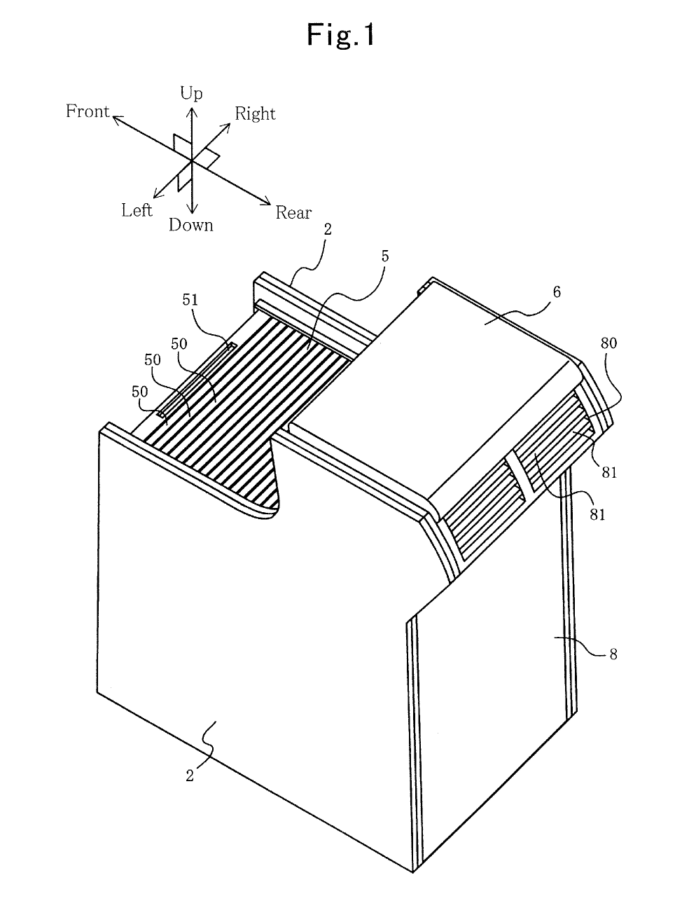

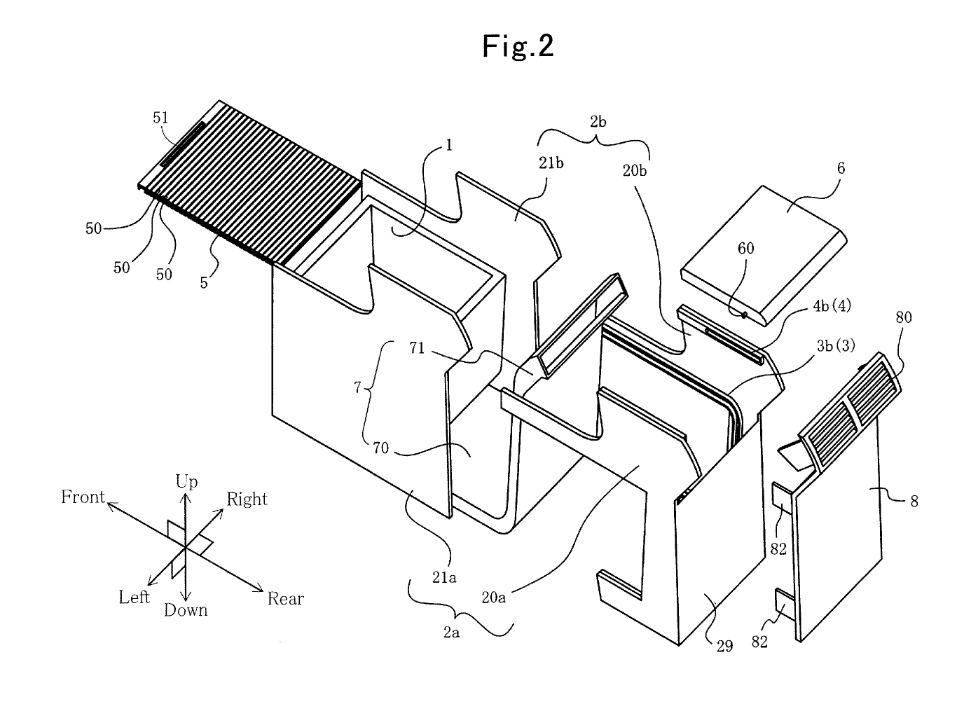

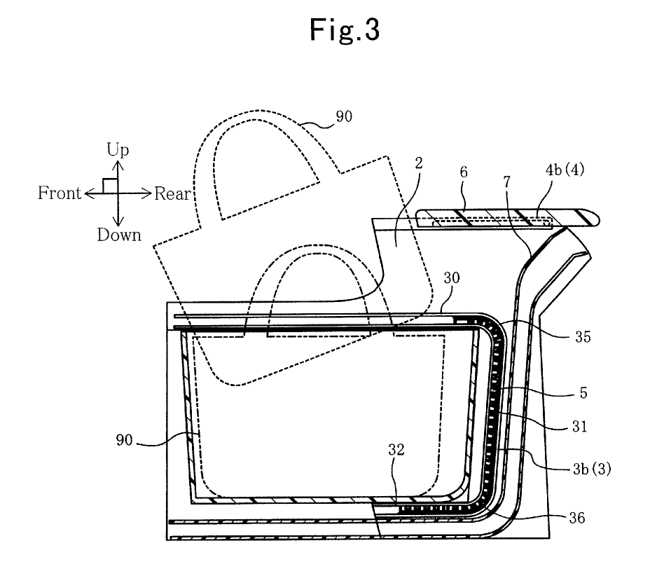

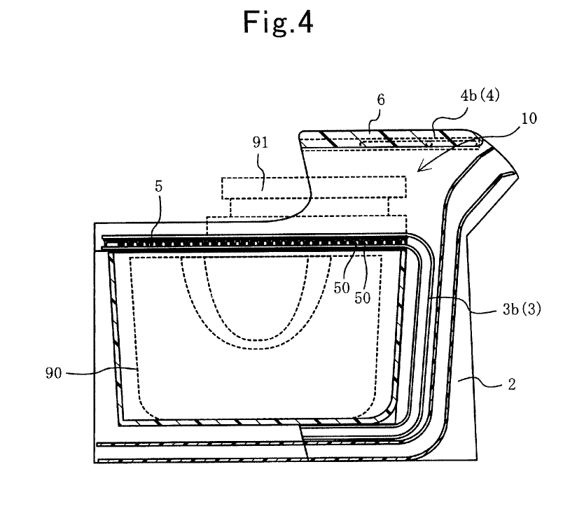

FIG. 1 illustrates a console box according to Embodiment No. 1 of the present invention in a perspective diagram. FIG. 2 illustrates the present console box according to Embodiment No. 1 in an exploded perspective diagram. FIG. 3 schematically illustrates how the present console box according to Embodiment No. 1 appears in a cross-sectional diagram in which it is cut imaginarily in the front/rear direction. FIG. 4 schematically illustrates how the present console box according to Embodiment No. 1, in which a tote bag is accommodated, in another cross-sectional diagram in which it is cut imaginarily in the front/rear direction. Note that FIG. 3 shows a console lid, one of the constituent elements of the present console box according to Embodiment No. 1, is placed at the opening position and FIG. 4 shows the console lid is placed at the closing position. Hereinafter, in the present specification, the terms, “up,” “down,” “right,” “left,” “front” and “rear,” designate the up, down, right, left, front and rear directions being given in FIGS. 1 and 2, respectively. Moreover, the “up/down direction” specifies the vehicular height-wise direction, the “right/left direction” specifies the vehicular width-wise direction, and the “front/rear direction” specifies the vehicular traveling direction. Note that, in the present specification, the “vehicular height-wise direction” is a concept that involves not only the vertical direction but also near-vertical directions crossing the vertical direction to make crossing angles that fall within ±30 degrees. Moreover, the “vehicular traveling direction” is a concept that involves not only a horizontal direction that coincides with the vehicular front/rear direction but also near-horizontal directions that cross the horizontal direction to make crossing angles falling within ±30 degrees. In addition, the “vehicular width-wise direction” is a concept that involves the other horizontal direction, which coincides with the vehicular width-wise direction, as well as near-horizontal directions that cross the other horizontal direction to make crossing angles falling within ±30 degrees.

As illustrated in FIGS. 1 and 2, especially in FIG. 2, the present console box according to Embodiment No. 1 comprises an accommodation compartment 1 (see FIG. 2), a pair of side panels 2, 2, a pair of rails 3, 3 for lid (see FIG. 2), a pair of rails 4, 4 for arm rest (see FIG. 2), a console lid 5, an arm rest 6, an air-conditioning duct 7 (see FIG. 2), and a decorative panel 8.

The accommodation compartment 1 is made of polypropylene (or PP), and is formed as a box shape that opens upward.

As illustrated in FIG. 2, the paired side panels 2, 2 are made up of a left side panel 2a being placed on the left side of the accommodation compartment 1, and a right side panel 2b being placed on the right side of the accommodation compartment 1. Moreover, the left side panel 2a is made up of a left inner-panel member 20a being put on the accommodation compartment 1, and a left outer-panel member 21a being put on the left side face of the left inner-panel member 20a. In addition, the right side panel 2b is made up of a right inner-panel member 20b being put on the accommodation compartment 1, and a right outer-panel member 21b being put on the right side face of the right inner-panel member 20b.

The left inner-panel member 20a, and the right inner-panel member 20b are made of synthetic resin (e.g., acrylonitrile-butadiene-styrene copolymer (or ABS)).

The left outer-panel member 21a, and the right outer-panel member 21b are made of resin (e.g., PP). Note that the left outer-panel member 21a and right outer-panel member 21b are molded integrally with the accommodation compartment 1.

Moreover, the left inner-panel member 20a, and the left outer-panel member 21a are individual parts that are molded independently of or separately from each other, but are then fastened together to integrate with each other by not-shown screws and nuts. Likewise, the right inner-panel member 20b, and the right outer-panel member 21b are individual parts that are molded independently of or separately from each other, but are then fastened together to integrate with each other by not-shown screws and nuts. Note that ABS making the inner-panel members 20a, 20b exhibits better rigidity than does PP, a major material for the outer-panel members 21a and 21b. As a result, the inner-panel members 20a, 20b show better rigidity than do the outer-panel members 21a, 21b. To put it differently, the inner-panel members 20a, 20b reinforce the outer-panel members 21a, 21b.

In addition, a connector wall member 29 integrates the rear end of the left inner-panel member 20a with the rear end of the right inner-panel member 20b. Note that the rear ends, which are joined by the connector wall member 29, are present below later-described paired rails 3, 3 (especially, a left first rail 3a (not shown) and a right first rail 3b). Moreover, the connector wall member 29 is molded integrally with the left inner-panel member 20a and right inner-panel member 20b.

The paired rails 3, 3 for lid are made of ABS. As illustrated in FIG. 2, the two rails 3, 3 are made up of a not-shown left first rail 3a being molded integrally with the left inner-panel member 20a, and a right first rail 3b being molded integrally with the right inner-panel member 20b. Note that the first left rail 3a and the first right rail 3b are made substantially symmetrically with each other in the right/left direction.

The left first rail 3a, and the right first rail 3b are formed as a rail shape, respectively, in which the constituent elements, an upper rail member 30, a side rail member 31 and a lower rail member 32, are connected in a form of substantially letter-“U.” The upper rail members 30, 30 are placed above the accommodation compartment 1, and are made so as to extend in the front/rear direction. Note that the upper rail members 30, 30 extend over the accommodation compartment 1 entirely in the front/rear direction, namely, in the vehicular traveling direction, as shown in FIGS. 3 and 4. The side rail members 31 are placed more rearward than is the accommodation compartment 1, and are made so as to be continuous with the upper rail members 30, 30 and then extend in the up/down direction, namely, in the vehicular height-wise direction. The lower rail members 32, 32 are placed below the accommodation compartment 1, and are made so as to be continuous with the side rail members 31, 31 and then extend in the vehicular traveling direction. Note that the lower rail members 30, 30 can extend under the accommodation compartment 1 partially in the vehicular traveling direction, as shown in FIG. 3.

The paired rails 4, 4 for arm rest are made of ABS. As illustrated in FIG. 2, the two rails 4, 4 are made up of a not-shown left second rail 4a being molded integrally with the left inner-panel member 20a, and a right second rail 4b being molded integrally with the right inner-panel member 20b. Note that the left second rail 4a and the right second rail 4b are made substantially symmetrically with each other in the right/left direction.

The left second rail 4a, and the right second rail 4b are formed as a substantially-linear railed shape, respectively. The left second rail 4a is placed above the left first rail 3a. Likewise, the right second rail 4b is placed above the right first rail 3b.

The console lid 5 comprises a plurality of lid segments 50 that are formed respectively as a strip shape. The lid segments 50 are arrayed to form a bellows shape. The neighboring lid segments are connected to each other so that they produce an expansible/contractible relative distance between them in the arraying direction. The console lid 5 is installed to the left first rail 3a at the left end, and is installed to the right first rail 3b at the right end. As a result, the console lid 5 slides along the paired lid rails 3, 3 while being guided by the two lid rails 3, 3. Note that, as illustrated in FIGS. 3 and 4, each of the lid rails 3, 3 is curved at the boundary 35 between the upper rail member 30 and the side rail member 31 and is further curved at the boundary 36 between the side rail member 31 and the lower rail member 32. However, the console lid 5 is guided by the paired lid rails 3, 3 while deforming or flexing, namely bending or curving, in such configurations that conform to the boundaries 35 and 36, because the console lid 5 has a bellows shape as a whole. Moreover, the console lid 5 slides between an opening position at which it opens the accommodation compartment 1, as shown in FIG. 3, and a closing position at which it closes the accommodation compartment 1, as shown in FIG. 4, or vice versa. Thus, the console lid 5 covers the accommodation compartment 1 openably and closably. In addition, the console lid 5 is provided with a dented pull tab 51 at the front end, as shown in FIGS. 1 and 2. The pull tab 51 serves as an operational end when a passenger operates the console lid 5 to open or close the accommodation compartment 1.

The arm rest 6 is made of resin, and is provided with a left attachment boss 60 and a not-shown right attachment boss 61. The left attachment boss 60 and right attachment boss 61 are attached to the left second rail 4a and right second rail 4b. Thus, the arm rest 6 is installed to the left inner panel member 20a and right inner panel member 20b by way of the paired arm-rest rails 4, 4. Moreover, the arm rest 6 slides in the front/rear direction while being guided by the two arm-rest rails 4, 4. Accordingly, it is possible for a driver sitting on the driver's seat to slide the arm rest 6 so as to fit the arm rest 6 to his or her elbow's position. As illustrated in FIGS. 2 through 4, the paired lid rails 3, 3, and the paired arm-rest rails 4, 4 are separated away from each other in the up/down direction. Consequently, the console lid 5, and the arm rest 6 are also separated away from each other in the up/down direction.

As illustrated in FIG. 2, the air-conditioning duct 7 is provided with a lower duct member 70, and a rear duct member 71. The rear duct member 71 is made so as to be continuous with the lower duct member 70 in the up/down direction, thereby giving the air-conditioning duct 7 a substantially letter-“L” cylindrical shape as a whole. The lower duct member 70, which is connected to a not-shown air-conditioning apparatus for vehicle, is placed under the accommodation compartment 1, and under the paired lid rails 3, 3 (especially, the lower rails 32, 32), as shown in FIGS. 3 and 4. The rear duct member 71, which extends in the vehicular height-wise direction, is placed at the rear of the accommodation compartment 1, and at the rear of the paired lid rails 3, 3 (especially, the side rails 31, 31), as shown in the drawings. The rear duct member 71 is provided with an upper end making an outlet port for air-conditioned air that is directed to the interior of vehicular passenger room.

The decorative panel 8 is attached to the rear ends of the left outer panel member 21a and right outer panel member 21b. The decorative panel 8 is made of PP, the same resin as that making the left outer panel member 21a and right outer panel member 21b, and is formed as a plate shape substantially. The decorative panel 8 is provided with an opening 80 at one of the opposite ends. Moreover, the opening 80 is provided with a plurality of fins, thereby functioning as a register for controlling the blowing direction of air-conditioned air that is blown from out of the air-conditioning duct 7. The decorative panel 8 covers the rear of the present console box according to Embodiment No. 1, thereby hiding the inside of the present console box. In addition, the decorative panel 8 is provided with a plurality of engagement claws 82. The engagement claws 82 are press fitted into the minute spatial clearances being formed between the left inner panel member 20a and the left outer panel member 21a, and between the right inner panel member 20b and the right outer panel member 21b, and are then held firmly between the left inner panel member 20a and the left outer panel member 21a, and between the right inner panel member 20b and the right outer panel member 21b. Thus, the decorative panel 8 is assembled with the paired side panels 2, 2. Note that, in the present console box according to Embodiment No. 1, the decorative panel 8 hardly contributes to the rigidities of the present console box in the vehicular height-wise direction and in the vehicular width-wise direction because it is a constituent element for simply hiding the inside of the present console box.

When a passenger places the console lid 5 at the opening position shown in FIG. 3, the accommodation compartment 1 is opened. On this occasion, it is possible for the passenger to put his or her baggage 90 into the accommodation compartment 1. When the passenger places the console lid 5 at the closing position shown in FIG. 4, the accommodation compartment 1 is closed. In this instance, the arm rest 6, the paired side panels 2, 2 (especially, the left inner panel member 20a and the right inner panel member 20b), and the console lid 5 demarcate a minor second accommodation compartment 10. The resulting second accommodation compartment 10 is present above the accommodation compartment 1, and is provided with a bottom wall that the console lid 5 makes. Moreover, the second accommodation compartment 10 is not closed at the front by a reinforcement wall, but is opened thereat. On this occasion, it is therefore possible for the passenger to accommodate relatively small-sized belongings 91, such as cellular phones or books, in the second accommodation compartment 10. In addition, in this instance, it is possible for the passenger to readily operate the control lid 5 to open the accommodation compartment 1, because the second accommodation compartment 10 is opened at the front. Note that another second accommodation compartment 10, though not shown in the drawings, is formed likewise when the console lid 5 is placed between the opening position and the closing position. It is possible for the passenger to accommodate his or her belongings 91 in such a second accommodation compartment 10 as well, although the resulting capacity of the second accommodation compartment 10 is smaller on this occasion than is the capacity of the second accommodation compartment 10 shown in FIG. 4.

In the console box according to Embodiment No. 1 of the present invention, the paired lid rails 3, 3 comprise the paired side rails 31, 31 that extend over the accommodation compartment 1 entirely in the vehicular height-wise direction. Accordingly, the two side rails 31, 31 can enhance the present console box according to Embodiment No. 1 fully in the vehicular height-wise direction even when the accommodation compartment 1 has a deep dish shape. Therefore, the present console box according to Embodiment No. 1 exhibits a better rigidity in the vehicular height-wise direction, although the present console box comprises such a deep-dished accommodation compartment 1 that can accommodate the large-sized baggage 90, such as tote bags, therein. Moreover, in the present console box according to Embodiment No. 1, the paired lid rails 3, 3 comprise the paired upper rails 30, 30 that extend over the accommodation compartment 1 entirely in the vehicular traveling direction. Consequently, the two upper rails 30, 30 can enhance the present console box according to Embodiment No. 1 fully in the vehicular traveling direction even when an accommodation compartment 1 has a long dimension in the vehicular traveling direction. Hence, the present console box according to Embodiment No. 1 exhibits a better rigidity in the vehicular traveling direction, although the present console box comprises such a long accommodation compartment 1 that can accommodate the large-sized baggage 90 therein.

The console lid 5 is placed between the paired lid rails 3, 3. That is, the console lid 5 bridges over between the paired side panels 2, 2. As a result, the console lid 5 can reinforce the console box according to Embodiment No. 1 of the present invention in the vehicular width-wise direction.

Moreover, when the console lid 5 is at the opening position, it is placed mainly on the paired side rail members 31, 31, as shown in FIG. 3. In this instance, the console lid 5 reinforces the side rail members 31, 31. Therefore, the console lid 5 can also reinforce the console box according to Embodiment No. 1 of the present invention in the vehicular height-wise direction when it is put at the opening position. Note that, in the present console box according to Embodiment No. 1, the paired upper rail members 30, 30 are placed partially on the console lid 5, the paired side rails 31, 31 are placed entirely on the console lid 5, and the paired lower rails 32, 32 are placed partially on the console lid 5, as shown in FIG. 3, when the console lid 5 is at the opening position. As a result, the console lid 5, which is turned into a substantially letter-“U” shape on this occasion, can reinforce the two side rails 31, 31 more firmly in the vehicular height-wise direction. Hence, the console lid 5, which is thus deformed to reinforce the paired side rails 31, 31, can also help the present console box according to Embodiment No. 1 exhibit a better rigidity in the vehicular height-wise direction.

In addition, when the console lid 5 is at the closing position, it is placed entirely on the paired upper rail members 30, 30 as shown in FIG. 4. On this occasion, the console lid 5 reinforces the two upper rail members 30, 30 in the vehicular travelling direction. As a result, when the console lid 5 is put at the closing position, it can also reinforce the console box according to Embodiment No. 1 of the present invention in the vehicular traveling direction.

Moreover, the paired arm-rest rails 4, 4, too, can reinforce the console box according to Embodiment No. 1 of the present invention in the vehicular traveling direction.

In addition, molding the accommodation compartment 1 and paired outer panel members 21, 21 integrally not only makes it possible to provide the console box according to Embodiment No. 1 of the present invention inexpensively, but also enables the resulting accommodation compartment 1, too, to reinforce the present console box according to Embodiment No. 1 in the vehicular width-wise direction, in the vehicular traveling direction and in the vehicular height-wise direction. Note that it is not necessarily required that the present console box according to Embodiment No. 1 comprise the accommodation compartment 1 and paired side panels 2a, 2b that are molded integrally. Moreover, it is not necessarily required that the accommodation compartment 1 be integrated with the left side panel 2a and right side panel 2b. Even if such is the case, the accommodation compartment 1 can reinforce the present console box according to Embodiment No. 1 in the vehicular width-wise direction at least.

The console box according to Embodiment No. 1 of the present invention comprises the console lid 5 that slides from the front toward the rear, or vice versa, to open and close the accommodation compartment 1. Hence, the present console box according to Embodiment No. 1 comprises the paired side rail members 31, 31 that are placed much nearer to the rear than is the accommodation compartment 1. However, in the present console box according to Embodiment No. 1, it is not necessarily required that the paired side rail members 31, 31 be placed much nearer to the rear than is the accommodation compartment 1. For example, when the console lid 5 slides from the rear toward the front, or vice versa, to open and close the accommodation compartment 1, the paired side rail members 31, 31 can be placed much nearer to the front than is the accommodation compartment 1.

Moreover, the console box according to Embodiment No. 1 of the present invention comprises the paired inner panel members 20, 20 (especially, the left inner panel member 20a and the right inner panel member 20b) that are integrated at the connector wall member 29. However, the present console box according to Embodiment No. 1 can be free of the connector wall member 29. The present console box according to Embodiment No. 1 exhibits better rigidities in the vehicular height-wise direction and in the vehicular traveling direction without any connector wall member 29, because the paired lid rails 3, 3 can reinforce the present console box in the two directions. In addition, the present console box according to Embodiment No. 1 exhibits a better rigidity in the vehicular width-wise direction without any connector wall member 29, because the console lid 5 can reinforce the present console box in that direction.

### Embodiment No. 2

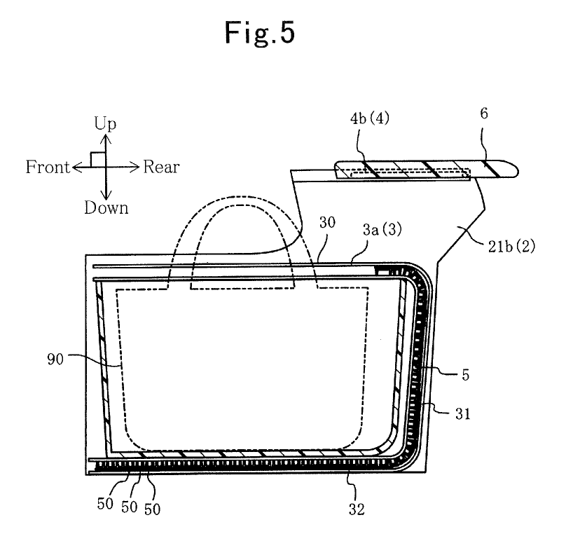

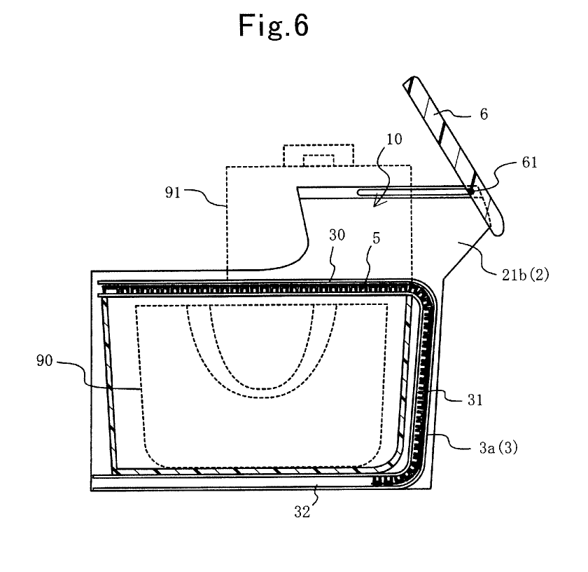

A console box according to Embodiment No. 2 of the present invention is virtually identical with the present console box according to Embodiment No. 1 except for the following features: the paired side panels are made up of an outer panel member alone, that is, the paired side panels are free of any inner panel member; the paired lid rails are molded independently of or separately from the two side panels; the arm rest is made rotatable; no air-conditioning duct is provided; the paired lid rails have a distinct configuration; and the console lid has a distinct configuration. FIGS. 5 and 6 schematically illustrate how the present console box according to Embodiment No. 2 appears when it is cut imaginarily in the front/rear direction in the cross-sectional diagram. Note that FIG. 5 shows how the present console box according to Embodiment No. 2 appears when the console lid is put at the opening position, whereas FIG. 6 shows how the present console box according to Embodiment No. 2 appears when the console lid is put at the closing position.

In the console box according to Embodiment No. 2 of the present invention, a pair of side panels 2, 2 are made up of a left outer panel member 21a (no shown) and a right outer panel member 21b alone. The left outer panel member 21a and right outer panel member 21b are made of resin, such as PP. The not-shown left outer panel member 21a is provided with a not-shown left second rail 4a that is molded integrally with the left outer panel member 21a. Likewise, the right outer panel member 21b is provided with a right second rail 4b that is molded integrally with the right outer panel member 21b. The arm rest 6 is attached to the not-shown left second rail 4a, and to the right second rail 4b. As illustrated in FIG. 6, the arm rest 6 can rotate about the rotary shaft 61 when it slides on the paired arm-rest rails 4, 4 rearward to the rear ends. As shown in the drawing, it is possible for a passenger to accommodate his or her relatively large-sized baggage 91 in the resulting second accommodation compartment 10, because the arm rest 6 rotates to open the second accommodation compartment 10 upward.

The paired lid rails 3, 3 are made of stainless steel, and are made up of a left lid rail 3a (not shown) and a right lid rail 3b. The left lid rail 3a is bonded on the left outer panel member 21a, and the right lid rail 3b is bonded on the right outer panel member 21b. Each of the lid rails 3, 3 is provided with an upper rail member 30, a side rail member 31, and a lower rail member 32 that form a substantially letter-“U” shape. Note that the lower rail member 32 extends over the accommodation compartment 1 entirely in the vehicular traveling direction.

The console box according to Embodiment No. 2 of the present invention comprises a console lid 5 that has a bellows shape and is made up of a plurality of lid segments 50 that are arrayed in the front/rear direction, in the same manner as the console lid 5 of the present console box according to Embodiment No. 1. In the present console box according to Embodiment No. 2, the console lid 5 has a length (namely, the length in the direction of arraying the lid segments 5) that is longer than that of the console lid 5 for the present console box according to Embodiment No. 1. The longer length makes it possible to locate the console lid 5 on a part of the paired upper rail members 30, 30, on the entire paired side rail members 31, 31, and on the entire paired lower rail members 32, 32, when the console lid 5 is at the opening position shown in FIG. 5. On the other hand, the longer length makes it possible to locate the console lid 5 on the entire paired upper rail members 30, 30, on the entire paired side rail members 31, 31, and on a part of the entire paired side lower members 32, 32, when the console lid 5 is at the closing position shown in FIG. 6.

Because of the above-described construction, not only the console box according to Embodiment No. 2 of the present invention comprises the console lid 5 that is reinforced by the paired lid rails 3, 3 in the vehicular travelling direction and in the vehicular height-wise direction, but also the present console box according to Embodiment No. 1 is always reinforced in turn by the console lid 5 proper in the vehicular width-wise direction and in the vehicular height-wise direction. Therefore, the present console box according to Embodiment No. 2 is better in the rigidities in the vehicular width-wise direction, in the vehicular height-wise direction and in the vehicular travelling direction, although it might be inferior to the present console box according to Embodiment No. 1 in terms of the rigidity of the paired side panels 2, 2.

Having now fully described the present invention, it will be apparent to one of ordinary skill in the art that many changes and modifications can be made thereto without departing from the spirit or scope of the present invention as set forth herein including the appended claims.

What is claimed is:

1. A console box to be disposed in a vehicular passenger room, the console box comprising:
a pair of side panels being made of resin, and being separated away from each other in a vehicular width-wise direction;
a pair of rails for lid, each of the paired rails being integrated with each of the paired side panels;
an accommodation module being formed as a box shape, and being disposed in a space between the paired side panels;
a console lid being formed as a bellows shape that is bendable along the paired rails for lid, covering the accommodation module so as to make the accommodation module openable and closable, and having opposite ends in the vehicular width-wise direction, one of the opposite ends being installed slidably to one of the paired rails for lid and the other one of the opposite ends being installed slidably to the other one of the paired rails for lid;
an arm rest being installed to the paired side panels, and being disposed above the console lid so as to separate away from the console lid; and
the paired rails for lid comprising:
an upper rail member being disposed above the accommodation module, and extending in a vehicular traveling direction; and
a side rail member being disposed more rearward, or more forward, than is the accommodation module, being disposed continuously to and from the upper rail member, and extending in a vehicular height-wise direction.

2. The console box according to claim 1, wherein the side rail member extends over the accommodation module entirely in the vehicular height-wise direction.

3. The console box according to claim 1, wherein the paired rails for lid are formed as a letter-U shape substantially to further comprise a lower rail member being disposed beneath the accommodation module, being disposed continuously to and from the side rail member, and extending in the vehicular traveling direction.

4. The console box according to claim 1, wherein one of the paired side panels comprises:
an inner panel member being integrated with one of the paired rails for lid; and
an outer panel member being disposed more outward in the vehicular width-wise direction than is the inner panel member, and being fastened to the inner panel member.

5. The console box according to claim 4, wherein:
the inner panel member is made of first resin;
the outer panel member is made of second resin;
the first resin exhibits greater rigidity than does the second resin.

6. The console box according to claim 4, wherein the inner panel member is molded integrally with the one of the paired rails for lid.

7. The console box according to claim 4, wherein the outer panel member is molded integrally with the accommodation module.

8. The console box according to claim 1, wherein the arm rest is disposed slidably to make a minor second accommodation module on the console lid.

9. The console box according to claim 1, wherein the arm rest is disposed rotatably to make a minor second accommodation module on the console lid.
